(19) United States
(12) Patent Application Publication
(10) Pub. No.: US 2014/0307830 A1
(43) Pub. Date: Oct. 16, 2014

(54) APPARATUS AND METHOD FOR OFFSET COMPENSATION IN HIGH-ORDER MODULATED ORTHOGONAL FREQUENCY DIVISION MULTIPLEXING (OFDM) TRANSMISSION

(71) Applicant: Electronics and Telecommunications Research Institute, Daejeon (KR)

(72) Inventors: Young Kwon HAHM, Daejeon (KR); Dong Joon CHOI, Daejeon (KR); Nam Ho HUR, Daejeon (KR)

(73) Assignee: Electronics and Telecommunications Research Institute, Daejeon (KR)

(21) Appl. No.: 14/245,277

(22) Filed: Apr. 4, 2014

(30) Foreign Application Priority Data
Apr. 10, 2013 (KR) 10-2013-0038934

(51) Int. Cl. H04L 25/08; H04L 27/26; H04L 25/02

(52) U.S. Cl. CPC H04L 25/08; H04L 25/0204; H04L 27/2662
USPC 375/296; 375/349

(57) ABSTRACT

An apparatus for offset compensation in high-order modulated orthogonal frequency division multiplexing (OFDM) transmission, the apparatus including a transmitter to configure a pilot signal for transmission and reception synchronization and distortion estimation as a frame, and transmit the frame, and a receiver to estimate a channel distortion of a received signal by estimating and compensating for a clock offset and a frequency offset with respect to the received signal.

### CROSS-REFERENCE TO RELATED APPLICATION

This application claims the benefit of Korean Patent Application No. 10-2013-0038934, filed on Apr. 10, 2013, in the Korean Intellectual Property Office, the disclosure of which is incorporated herein by reference.

### BACKGROUND

1. Field of the Invention

The present invention relates to transmission technology in a hybrid fiber-coaxial (HFC) downstream cable network, and more particularly, to an apparatus and method for estimating and compensating for a transmission and reception clock offset and a frequency offset in orthogonal frequency division multiplexing (OFDM) transmission using high-order modulation and demodulation, for example, 4096-quadrature amplitude modulation (QAM).

2. Description of the Related Art

A downstream physical layer transmission scheme currently used in a cable network is employing a single carrier scheme. In digital video broadcasting-cable 2 (DVB-C2), transmission standards developed as a next generation cable network transmission scheme, orthogonal frequency division multiplexing (OFDM) corresponding to a multicarrier scheme is adopted.

The OFDM scheme may easily compensate for a signal distortion caused by multiple reflected waves in a channel, and be easily applied to technologies related to a multiple-input multiple-output (MIMO) antenna. Thus, the OFDM scheme is frequently used for high-speed signal transmission. However, the OFDM scheme may be sensitive to a transmission and reception clock offset and a frequency offset. In particular, when high-order modulation and demodulation, for example, 4096-quadrature amplitude modulation (QAM), is used, the sensitivity may increase. Thus, when the high-order modulation and demodulation, for example, 4096-QAM, is used, accurate estimation of and compensation for the transmission and reception clock offset and the frequency offset may be demanded.

In a cable network, ingress noise of a large signal may occur suddenly in an indoor receiving environment and thus, accurate estimation of a clock offset and a frequency offset may be difficult. However, a conventional method suitable for low-order modulations, for example, 16-QAM, 64-QAM, and 256-QAM, may not provide an appropriate performance.

Accordingly, to enable transmission and reception of an OFDM-based transmission system using high-order modulation and demodulation in a downstream cable network, technology related to a transmission system that may accurately estimate and compensate for a clock offset between transmission and reception and a frequency offset, without increasing a system complexity.

### SUMMARY

According to an aspect of the present invention, there is provided an apparatus for offset compensation in high-order modulated orthogonal frequency division multiplexing (OFDM) transmission, the apparatus including a transmitter to configure a pilot signal for transmission and reception synchronization and distortion estimation as a frame and transmit the frame, and a receiver to estimate a channel distortion of a received signal by estimating and compensating for a clock offset and a frequency offset with respect to the received signal.

The transmitter may include a frame configuration unit to configure a frame including a pilot signal for transmission and reception synchronization and multicarrier channel distortion estimation, an operation unit to convert a frequency domain signal to a time domain signal by performing a block based operation on the frame, and eliminate channel interference, and a converter to convert a digital signal associated with the frame to an analog signal, perform conversion to a radio frequency (RF) band and amplification on the frame, and transmit the frame.

The frame configuration unit may configure the frame by inserting a continuous pilot signal into subcarrier channels included in a plurality of symbols.

The receiver may include a clock offset compensator to estimate a clock offset of a received signal, and generate a first signal in which a clock offset between transmission and reception is corrected, a first frequency compensator to perform symbol synchronization on the first signal, estimate a fine frequency offset, and generate a second signal in which the fine frequency offset is compensated for, a frame synchronizer to convert the second signal to a frequency domain signal, and perform frequency synchronization and frame synchronization, a second frequency compensator to estimate a residual frequency offset of the synchronized second signal, and generate a third signal in which the residual frequency offset is compensated for, and an equalizer to perform channel distortion estimation and channel equalization on the received signal based on the third signal.

The receiver may further include a converter to convert the received signal to a baseband signal, and convert an analog signal to a digital signal.

The first frequency compensator may generate the second signal based on a feedback signal associated with the residual frequency offset, estimated by the second frequency compensator, of the synchronized second signal.

The received signal may be provided in a structure of a frame including a plurality of symbols.

The clock offset compensator may estimate the clock offset based on a continuous pilot signal included in two consecutive symbols, among the plurality of symbols included in the received signal.

The second frequency compensator may perform burst noise filtering on the third signal.

According to another aspect of the present invention, there is provided a method of compensating for an offset with respect to a received signal in high-order modulated OFDM transmission, the method including estimating a clock offset of the received signal and generating a first signal in which a clock offset between transmission and reception is corrected, performing symbol synchronization on the first signal, estimating a fine frequency offset, and generating a second signal in which the fine frequency offset is compensated for, converting the second signal to a frequency domain signal, and performing frequency synchronization and frame synchronization, estimating a residual frequency offset of the synchronized second signal, and generating a third signal in which the residual frequency offset is compensated for, and performing channel distortion estimation and channel equalization on the received signal based on the third signal.

The received signal may be provided in a structure of a frame comprising a plurality of symbols.

The generating of the first signal may include estimating the clock offset based on a continuous pilot signal included in two consecutive symbols, among the plurality of symbols included in the received signal.

The generating of the second signal may include generating the second signal based on a feedback signal associated with the residual frequency offset of the synchronized second signal.

The generating of the third signal may include performing burst noise filtering on the third signal.

According to still another aspect of the present invention, there is provided a method of configuring a frame for offset compensation in high-order modulated OFDM transmission, the method including configuring a frame including a pilot signal for transmission and reception synchronization and multicarrier channel distortion estimation, converting a frequency domain signal to a time domain signal by performing a block based operation on the frame, and eliminating channel interference, and converting a digital signal associated with the frame to an analog signal, performing conversion to an RF band and amplification on the frame, and transmitting the frame.

The configuring may include configuring the frame by inserting a continuous pilot signal into subcarrier channels included in a plurality of symbols.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for offset compensation according to an embodiment of the present invention;

FIG. 2 is a block diagram illustrating a configuration of a transmitter of an apparatus for offset compensation according to an embodiment of the present invention;

FIG. 3 is a block diagram illustrating a configuration of a receiver of an apparatus for offset compensation according to an embodiment of the present invention;

FIG. 4 is a diagram illustrating a configuration of a signal frame according to an embodiment of the present invention;

FIG. 5 is a diagram illustrating a process of estimating a clock offset according to an embodiment of the present invention;

FIG. 6 is a graph illustrating a change in phase with respect to a continuous pilot signal between consecutive symbols according to an embodiment of the present invention;

FIG. 7 is a diagram illustrating a process of estimating a frequency offset according to an embodiment of the present invention;

FIG. 8 is a flowchart illustrating a method of compensating for an offset with respect to a received signal according to an embodiment of the present invention; and

FIG. 9 is a flowchart illustrating a method of configuring a frame for offset compensation according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The terms used herein are mainly selected from general terms currently being used in light of functions in the present invention. However, the meanings of the terms used herein may be changed to be consistent with the intent of an operator in the art, a custom, or the appearance of new technologies.

In addition, in a specific case, most appropriate terms are arbitrarily selected by the applicant for ease of description and/or for ease of understanding. In this instance, the meanings of the arbitrarily used terms will be clearly explained in the corresponding description. Hence, the terms should be understood not by the simple names of the terms but by the meanings of the terms and the following overall description of this specification.

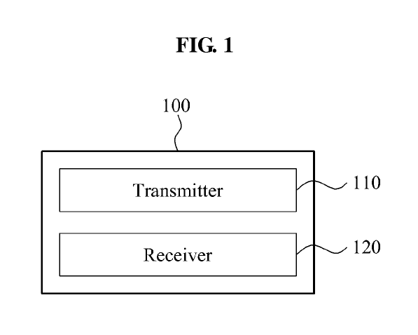

FIG. 1 is a block diagram illustrating an apparatus 100 for offset compensation in high-order modulated orthogonal frequency division multiplexing (OFDM) transmission according to an embodiment of the present invention.

Referring to FIG. 1, the offset compensation apparatus 100 may include a transmitter 110 and a receiver 120.

The transmitter 110 may configure a pilot signal for transmission and reception synchronization and channel distortion estimation as a frame, and transmit the frame.

The transmitter 110 may include a frame configuration unit, an operation unit, and a converter.

The frame configuration unit may configure a frame including a pilot signal for transmission and reception synchronization and multicarrier channel distortion estimation.

In this example, the frame configuration unit may configure the frame by inserting a continuous pilot signal into subcarrier channels included in a plurality of symbols.

The operation unit may convert a frequency domain signal to a time domain signal by performing a block based operation on the frame, and eliminate channel interference.

The converter may convert a digital signal associated with the frame to an analog signal, perform conversion to a radio frequency (RF) band and amplification on the frame, and transmit the frame.

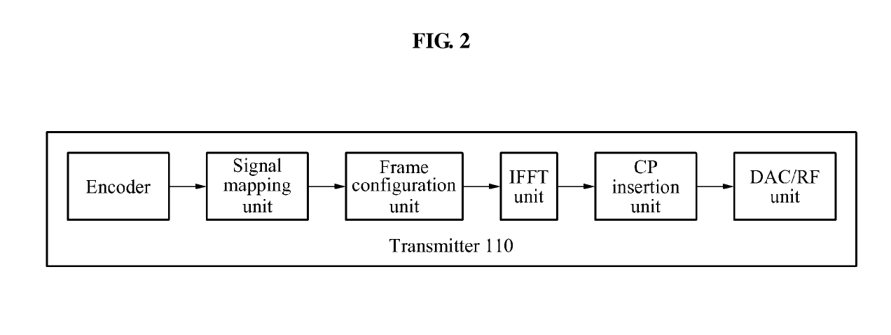

The transmitter 100 will be described in detail with reference to FIG. 2.

The receiver 120 may estimate a channel distortion of a received signal by estimating and compensating for a clock offset and a frequency offset with respect to the received signal.

The receiver 120 may include a clock offset compensator, a first frequency compensator, a frame synchronizer, a second frequency compensator, and an equalizer.

The received signal may be provided in a structure of a frame including a plurality of symbols.

The clock offset compensator may estimate the clock offset of the received signal, and generate a first signal in which a clock offset between transmission and reception is corrected.

The clock offset compensator may estimate the clock offset based on a continuous pilot signal included in two consecutive symbols, among the plurality of symbols included in the received signal.

The first frequency compensator may perform symbol synchronization on the first signal, estimate a fine frequency offset, and generate a second signal in which the fine frequency offset is compensated for.

The first frequency compensator may generate the second signal based on a feedback signal associated with a residual frequency offset of the synchronized second signal. The residual frequency offset of the synchronized second signal may be estimated by the second frequency compensator.

The frame synchronizer may convert the second signal to a frequency domain signal, and perform frequency synchronization and frame synchronization.

The second frequency compensator may estimate the residual frequency offset of the synchronized second signal, and generate a third signal in which the residual frequency offset is compensated for.

The second frequency compensator may also perform burst noise filtering on the third signal.

The equalizer may perform channel distortion estimation and channel equalization on the received signal based on the third signal.

In another example, the receiver 120 may further include a converter to convert the received signal to a baseband signal, and convert an analog signal to a digital signal.

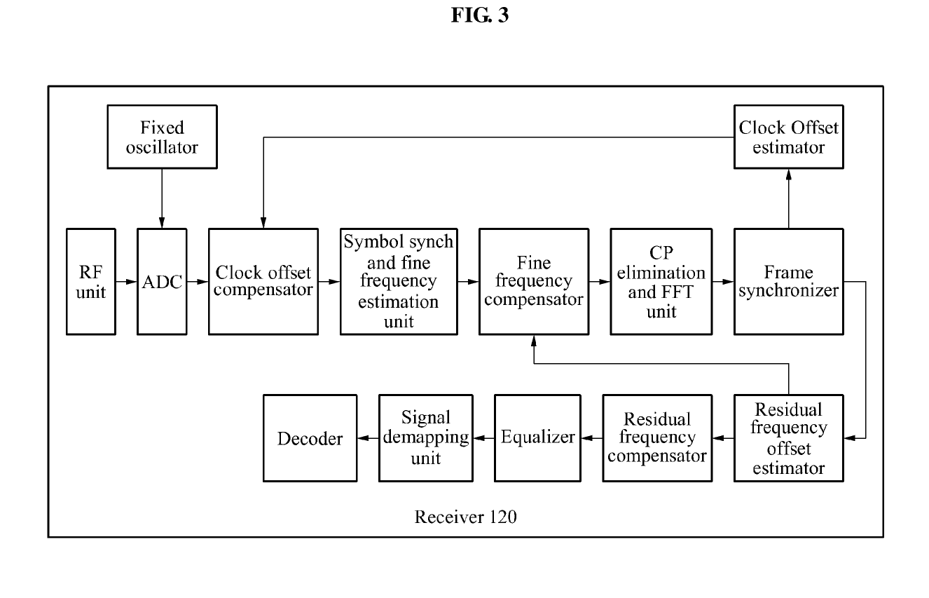

A configuration of the receiver 120 will be described in detail with reference to FIG. 3.

FIG. 2 is a block diagram illustrating a configuration of the transmitter 110 of the apparatus 100 for offset compensation according to an embodiment of the present invention.

The transmitter 110 may configure a pilot signal as a frame and transmit the frame for transmission and reception synchronization and channel distortion estimation.

The transmitter 110 may perform channel encoding and signal mapping for error correction with respect to a signal to be transmitted.

The signal mapping may be performed using a scheme of, for example, mapping a bit signal to a 4096-quadrature amplitude modulation (QAM) modulated signal.

When the channel encoding and the signal mapping are performed, the frame configuration unit may configure a transmission frame including a preamble section containing service information and a data section containing actual data to be transmitted, and a physical layer transmission parameter.

The pilot signal for transmission and reception synchronization and multicarrier channel distortion estimation may be included in the preamble section and the data section.

The operation unit may perform an IFFT operation on the configured transmission frame such that the transmission frame may be converted to a time domain signal.

In this example, the operation unit may apply the IFFT operation in block, for example, OFDM symbol units to the transmission frame.

The operation unit may eliminate inter-symbol interference (ISI) and inter-channel interference (ICI) from the transmission frame through CP insertion.

The operation unit may insert a CP greater than a channel delay time, for example, using a scheme of copying a portion at an end of an IFFT output signal block and disposing the copied portion at a front portion of an IFFT output signal, to minimize the ISI and the ICI with respect to the transmission frame.

When the foregoing operation process is performed on the frame, the converter may convert a digital signal input from the CP insertion to an analog signal, convert a baseband signal to an RF band signal, and amplify and transmit the frame.

FIG. 3 is a block diagram illustrating a configuration of the receiver 120 of the apparatus 100 for offset compensation according to an embodiment of the present invention.

The receiver 120 may estimate a channel distortion of a signal received over a cable network by estimating and compensating for a clock offset and a frequency offset with respect to the received signal.

Referring to FIG. 3, the converter, for example, an RF/analog-to-digital converter (ADC), may convert an RF signal received over the cable network to a baseband signal, and convert an analog signal to a digital signal.

The clock offset compensator may compensate for a clock offset between transmission and reception based on a clock offset estimated by a clock offset estimator.

The first frequency compensator may perform symbol synchronization and fine frequency estimation, and compensate for a fine frequency offset based on the estimated fine frequency.

The first frequency compensator may perform OFDM symbol synchronization using a CP, and estimate the fine frequency offset.

The first frequency compensator may compensate for the fine frequency offset based on the estimated fine frequency offset and a residual frequency offset to be estimated.

The frame synchronizer may eliminate a CP from a signal input from a first frequency compensator, convert a time domain signal to a frequency domain signal, and perform integer frequency synchronization and frame synchronization based on a pilot signal pattern.

The second frequency compensator may estimate an offset with respect to a residual frequency remaining after the fine frequency offset is compensated for by the first frequency compensator. The estimated residual frequency offset may be used for residual frequency offset compensation and the fine frequency compensation performed by the first frequency compensator.

The second frequency compensator may perform compensation using the estimated residual frequency offset, and provide the signal to an equalizer.

The equalizer may estimate a channel distortion state of frequency selective fading resulting from multicarrier interference based on a previously known pilot signal, and perform channel equalization, for example, 1-tap channel equalization, based on channel distortion estimation information.

In the channel distortion estimation, by dividing a value of a subcarrier by a previously known pilot value, a channel distortion state with respect to the subcarrier may be estimated. The subcarrier may correspond to a frequency cell in which pilot symbols corresponding to FFT outputs are disposed. Hereinafter, all divisions may correspond to complex number divisions.

An output signal of the equalizer on which the channel distortion estimation and the channel equalization are performed may be demapped and decoded based on a binary number by a decoder.

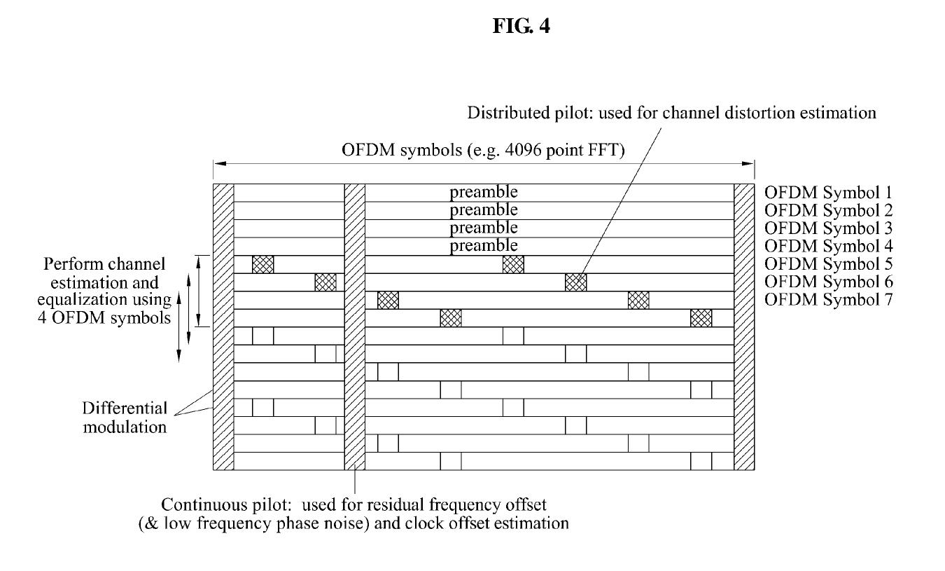

FIG. 4 is a diagram illustrating a configuration of a signal frame according to an embodiment of the present invention.

Referring to FIG. 4, a single frame may include a plurality of OFDM symbols. The frame may be divided into a preamble section and a data section, and include a pilot signal for transmission and reception synchronization and multicarrier channel distortion estimation.

To estimate a residual frequency offset and a clock offset in the frame, a continuous pilot signal may be inserted into arbitrary subcarrier channels of OFDM symbols, as shown in FIG. 4. For example, a pilot signal of a differentially modulated or identically modulated signal between the OFDM symbols may be inserted.

The continuous pilot signal may be disposed periodically or aperiodically in a single OFDM symbol.

However, in disposition of a pilot signal for estimating a channel distortion caused by multiple reflected waves, when a pilot signal is inserted in a single OFDM symbol at predetermined intervals according to the Nyquist sampling law, a number of pilot signals may increase and thus, a transmission efficiency may decrease. Accordingly, a pilot signal to be used in a single OFDM may be disposed to be distributed over many OFDM symbols, for example, four OFDM symbols, as shown in FIG. 4.

The distributed disposition may be enabled based on characteristics of a cable channel with a relatively slow change in channel distortion. However, when a residual frequency offset is present, a phase among four OFDM symbols may be changed and thus, accurate estimation of the channel distortion may be difficult. Accordingly, accurate performance of residual frequency offset compensation may be necessary.

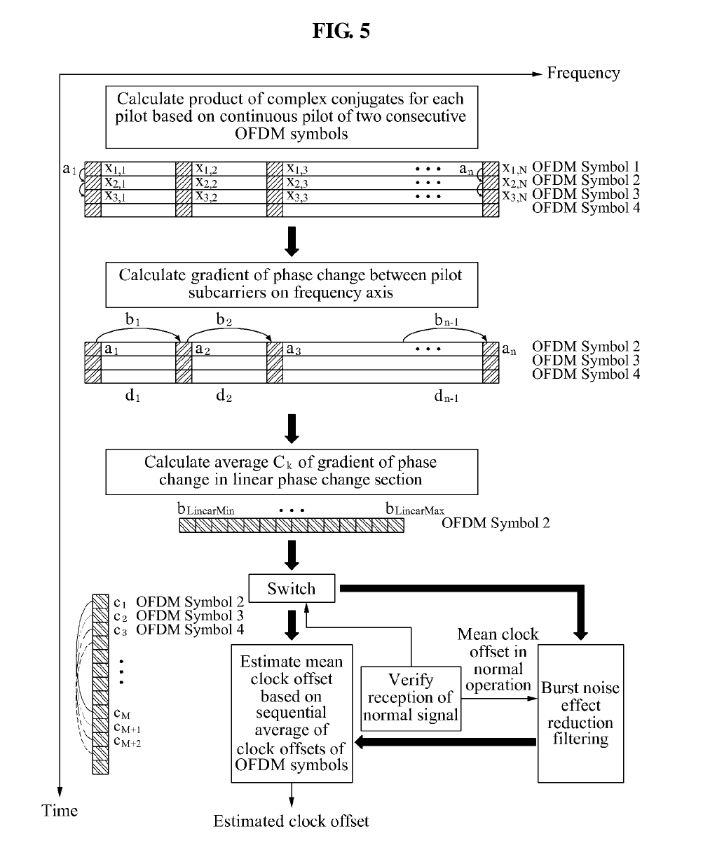

FIG. 5 is a diagram illustrating a process of estimating a clock offset according to an embodiment of the present invention.

The clock offset compensator may estimate a clock offset for each OFDM symbol based on a continuous pilot signal in two consecutive OFDM symbols.

For example, the clock offset compensator may estimate a first clock offset based on two ODFM symbols, for example, a first OFDM symbol and a second OFDM symbol, and calculate a product of complex conjugates with respect to the continuous pilot signal of the two OFDM symbols, as expressed by Equation 1.

aᵢ=x_{1,i}*conjugate(x_{2,i}), i=1, . . . , n [Equation 1]

In Equation 1, conjugate denotes a complex conjugate number.

Based on a result of Equation 1, a change in phase on a frequency axis may be estimated. The change in phase between pilot subcarriers on the frequency axis may be estimated as expressed by Equation 2.

bᵢ=angle(aᵢ*conjugate(aᵢ₊₁)), i=1, . . . , n−1 [Equation 2]

A clock offset for each OFDM symbol may be estimated using a gradient of a linearly changed portion with respect to estimated changes in phase between the continuous pilot subcarriers.

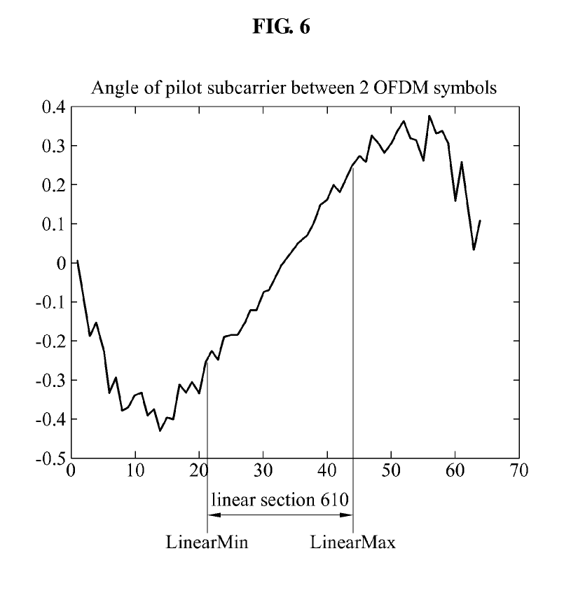

The change in phase with respect to the continuous pilot signal between the consecutive symbols may be presented as shown in a graph of FIG. 6, and in particular, the linear change in the estimated changes in phase between the continuous pilot subcarriers may correspond to a gradient of a linear section 610 of FIG. 6.

The gradient may be calculated as expressed by Equation 3.

$${c}_{k} = \begin{matrix}\frac{{\sum }_{i = LinearMax}^{LinearMax} \frac{{b}_{i}}{{d}_{i}}}{( LinearMax - LinearMax )} \cdot \\ \frac{FFTsize}{2 π * ( FFTsize + CPsize )}\end{matrix} \qquad [ Equation 3 ]$$

In Equation 3, dᵢ denotes a distance between pilot signals, for example, a number of frequency cells. A left index of the linear section may be denoted as LinearMin, and a right index may be denoted as LinearMax. A size of an FFT may be denoted as FFTsize, and a size of a CP may be denoted as CPsize.

The clock offset compensator may estimate a second clock offset c₂ by performing the foregoing process using two OFDM symbols, for example, the second OFDM symbol and a third OFDM symbol. Similarly, the clock offset compensator may estimate a third clock offset c₃ using two OFDM symbols, for example, the third OFDM symbol and a fourth OFDM symbol. By iterating the calculation process, estimated clock offsets may be obtained.

Through a sequential average of estimated clock offsets with respect to a plurality of OFDM symbols, for example, M OFDM symbols in a case of FIG. 5, a mean clock offset mean_clock_offsetₘ may be calculated for each OFDM symbol. The mean clock offset may be calculated as expressed by Equation 4.

$$mean\_clock {\_ offset}_{m} = \frac{{\sum }_{k = m - M + 1}^{m} {c}_{k}}{M} \qquad [ Equation 4 ]$$

Clock offset compensation may be performed using the mean clock offset estimated using the foregoing scheme.

When the mean clock offset is compensated for, a transmission and reception offset may decrease, and a subsequently estimated mean clock offset may follow an offset which maintains a small value and changes slowly.

However, when a high level of burst noise occurs suddenly, the burst noise may cause a great difference between an estimated clock offset Cₖ of each OFDM symbol and an estimated mean clock offset in a normal state. Thus, there may be a great difference from an actual clock offset although a sequential average of OFDM symbols is used.

In addition, the burst noise may have a relatively great value and affect subsequent sequential averages, thereby causing successive great signal distortions for a period much longer than a period during which the burst noise occurs. Thus, there may be a risk of errors which may not be overcome by means of a robust error correcting encoder.

To overcome the risk, whether a signal is received normally may be evaluated. When a signal is received normally, burst noise effect reduction filtering may be additionally performed in a case of an occurrence of burst noise, as follows.

For example, through the burst noise effect reduction filtering, a clock offset Cₖ of each OFDM symbol may be replaced with a clock offset Cₖ₋₁ of a previous OFDM symbol when an absolute value of the difference between the clock offset Cₖ of each OFDM symbol and the mean clock offset in a normal operation exceeds a predetermined threshold.

In this example, the threshold may be set differentially based on a demodulation level in use, and an appropriate value may be recommended through a simulation.

After the burst noise effect reduction filtering is performed, the mean clock offset may be calculated based on the sequential average of the estimated clock offsets of the plurality of OFDM symbols, for example, the M OFDM symbols in the case of FIG. 5.

The estimated mean clock offset may be used for clock offset compensation as described above, and the transmission and reception clock offset compensation may be performed.

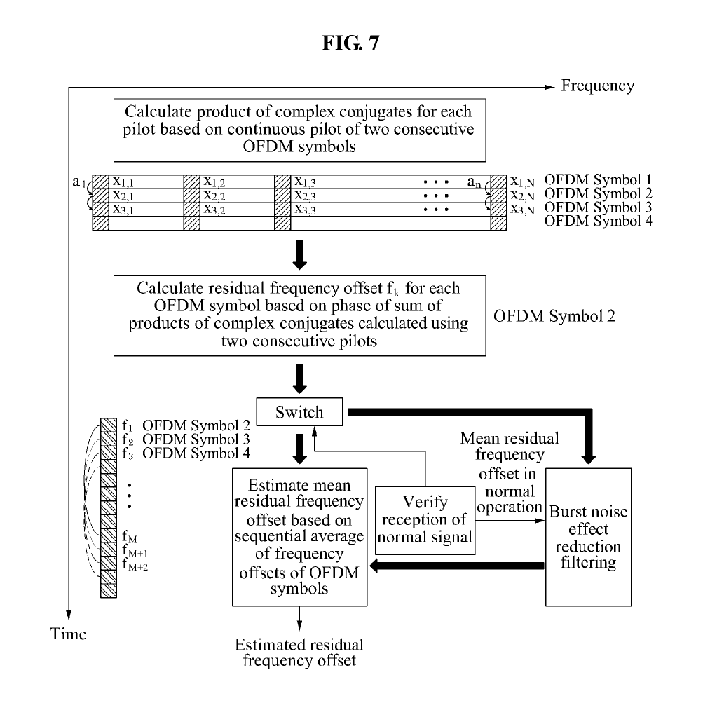

FIG. 7 is a diagram illustrating a process of estimating a frequency offset according to an embodiment of the present invention.

The second frequency compensator may estimate a clock frequency offset for each OFDM symbol, based on a continuous pilot signal in two consecutive OFDM symbols.

For example, the second frequency compensator may estimate a first residual frequency offset based on two OFDM symbols, for example, a first OFDM symbol and a second OFDM symbol, and calculate a product of complex conjugate with respect to the continuous pilot signal of the two OFDM symbols, as expressed by Equation 5.

aᵢ=x_{1,i}*conjugate(x_{2,i}), i=1, . . . , N [Equation 5]

In Equation 5, N denotes a number of continuous pilot signals included in a single OFDM symbol.

By obtaining a phase of a sum of values aᵢ obtained using Equation 5 with respect to all continuous pilot signals on a frequency axis in the OFDM symbols, a residual frequency offset f₁ may be estimated for each OFDM symbol, as expressed by Equation 6.

$${f}_{k} = \frac{angle ( {\sum }_{i = 1}^{N} {a}_{i} ) * FFTsize}{2 π * ( FFTsize + CPsize )} \qquad [ Equation 6 ]$$

The second frequency compensator may estimate a second residual frequency offset f₂ by performing the foregoing process using two OFDM symbols, for example, the second OFDM symbol and a third OFDM symbol. Similarly, the second frequency compensator may estimate a third residual frequency offset f₃ using two OFDM symbols, for example, the third OFDM symbol and a fourth OFDM symbol. By iterating the foregoing process, a plurality of residual frequency offsets may be obtained.

Through a sequential average of estimated residual frequency offsets with respect to a plurality of OFDM symbols, for example, M OFDM symbols in a case of FIG. 7, a mean residual frequency offset may be calculated, as expressed by Equation 7.

$$mean\_freq {\_ offset}_{m} = \frac{{\sum }_{k = m - M + 1}^{m} {f}_{k}}{M} \qquad [ Equation 7 ]$$

The residual frequency offset compensation may be performed based on the residual offsets estimated using the foregoing scheme. In addition, the residual frequency offsets may also be used for fine frequency offset compensation.

The estimated mean clock offset may follow an offset that maintains a small value and changes slowly. However, when a high level of burst noise is present, the burst noise may cause a great difference between an estimated residual frequency offset fₖ of each OFDM symbol and an estimated mean clock offset in a normal state. Thus, there may be a great difference from an actual residual frequency offset although a sequential average of OFDM symbols is used.

In addition, the burst noise may have a relatively great value and affect subsequent sequential averages, thereby causing successive great signal distortions for a period much longer than a period during which the burst noise occurs. Thus, there may be a risk of errors which may not be overcome by means of a robust error correcting encoder.

To overcome the risk, whether a signal is received normally may be evaluated. When a signal is received normally, burst noise effect reduction filtering may be additionally performed in a case of an occurrence of burst noise, as follows.

For example, through the burst noise effect reduction filtering, a residual frequency offset fₖ of each OFDM symbol may be replaced with a residual frequency offset fₖ₋₁ of a previous OFDM symbol when an absolute value of the difference between the residual frequency offset fₖ of each OFDM symbol and the mean residual frequency offset in a normal operation exceeds a predetermined threshold.

After the burst noise effect reduction filtering is performed, the mean residual frequency offset may be calculated based on the sequential average of the estimated clock offsets of the plurality of OFDM symbols, for example, the M OFDM symbols in the case of FIG. 5.

The estimated residual frequency offsets may be used for residual frequency offset compensation as described above, and the foregoing process may be performed continually, until a single frame is terminated.

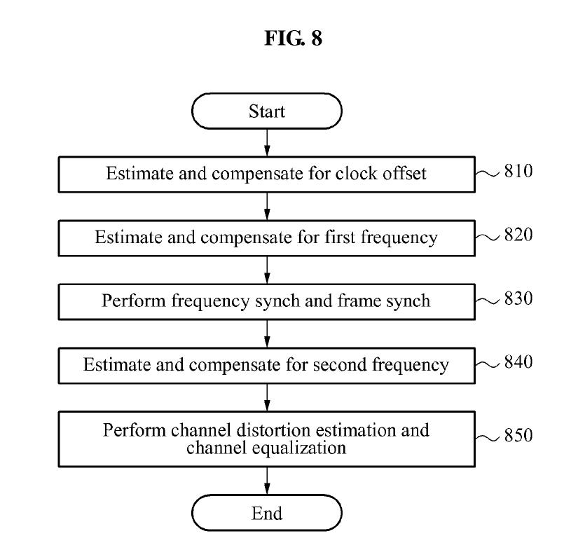

FIG. 8 is a flowchart illustrating a method of compensating for an offset with respect to a received signal in high-order modulated OFDM transmission according to an embodiment of the present invention.

In operation 810, the clock offset estimator may estimate a clock offset of the received signal and generate a first signal in which a clock offset between transmission and reception is corrected.

The received signal may be provided in a structure of a frame including a plurality of symbols.

The clock offset compensator may estimate the clock offset based on a continuous pilot signal included in two consecutive symbols, among the plurality of symbols.

In operation 820, the first frequency compensator may perform symbol synchronization on the first signal, estimate a fine frequency offset, and generate a second signal in which the fine frequency offset is compensated for.

In operation 830, the frame synchronizer may convert the second signal to a frequency domain signal, and perform frequency synchronization and frame synchronization.

In operation 840, the second frequency compensator may estimate a residual frequency offset of the synchronized second signal, and generate a third signal in which the residual frequency offset is compensated for.

The first frequency compensator may generate the second signal based on a feedback signal associated with the residual frequency offset of the synchronized second signal.

The second frequency compensator may perform burst noise filtering on the third signal.

In operation 850, the equalizer may perform channel distortion estimation and channel equalization on the received signal based on the third signal.

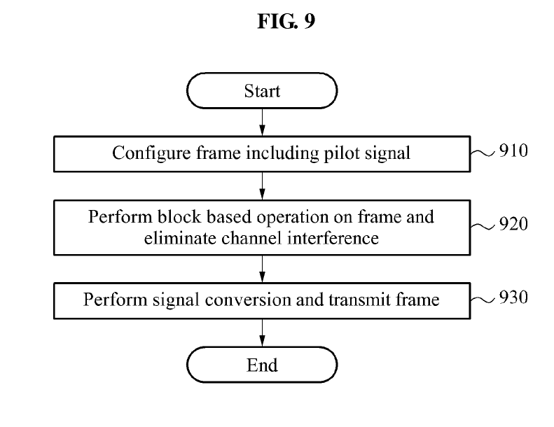

FIG. 9 is a flowchart illustrating a method of configuring a frame for offset compensation in high-order modulated OFDM transmission according to an embodiment of the present invention.

In operation 910, the frame configuration unit may configure a frame including a pilot signal for transmission and reception synchronization and multicarrier channel distortion estimation.

The frame configuration unit may configure the frame by inserting a continuous pilot signal into subcarrier channels included in a plurality of symbols.

In operation 920, the operation unit may convert a frequency domain signal to a time domain signal by performing a block based operation on the frame, and eliminate channel interference.

In operation 930, the converter may convert a digital signal associated with the frame to an analog signal, perform conversion to an RF band and amplification on the frame, and transmit the frame.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The methods according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for offset compensation in high-order modulated orthogonal frequency division multiplexing (OFDM) transmission, the apparatus comprising:
a transmitter to configure a pilot signal for transmission and reception synchronization and distortion estimation as a frame and transmit the frame; and
a receiver to estimate a channel distortion of a received signal by estimating and compensating for a clock offset and a frequency offset with respect to the received signal.

2. The apparatus of claim 1, wherein the transmitter comprises:
a frame configuration unit to configure a frame comprising a pilot signal for transmission and reception synchronization and multicarrier channel distortion estimation;
an operation unit to convert a frequency domain signal to a time domain signal by performing a block based operation on the frame, and eliminate channel interference; and
a converter to convert a digital signal associated with the frame to an analog signal, perform conversion to a radio frequency (RF) band and amplification on the frame, and transmit the frame.

3. The apparatus of claim 2, wherein the frame configuration unit configures the frame by inserting a continuous pilot signal into subcarrier channels included in a plurality of symbols.

4. The apparatus of claim 1, wherein the receiver comprises:
a clock offset compensator to estimate a clock offset of a received signal, and generate a first signal in which a clock offset between transmission and reception is corrected;
a first frequency compensator to perform symbol synchronization on the first signal, estimate a fine frequency offset, and generate a second signal in which the fine frequency offset is compensated for;
a frame synchronizer to convert the second signal to a frequency domain signal, and perform frequency synchronization and frame synchronization;
a second frequency compensator to estimate a residual frequency offset of the synchronized second signal, and generate a third signal in which the residual frequency offset is compensated for; and
an equalizer to perform channel distortion estimation and channel equalization on the received signal based on the third signal.

5. The apparatus of claim 4, wherein the receiver further comprises:
a converter to convert the received signal to a baseband signal, and convert an analog signal to a digital signal.

6. The apparatus of claim 4, wherein the first frequency compensator generates the second signal based on a feedback signal associated with the residual frequency offset, estimated by the second frequency compensator, of the synchronized second signal.

7. The apparatus of claim 4, wherein the received signal is provided in a structure of a frame comprising a plurality of symbols.

8. The apparatus of claim 7, wherein the clock offset compensator estimates the clock offset based on a continuous pilot signal included in two consecutive symbols, among the plurality of symbols included in the received signal.

9. The apparatus of claim 4, wherein the second frequency compensator performs burst noise filtering on the third signal.

10. A method of compensating for an offset with respect to a received signal in high-order modulated orthogonal frequency division multiplexing (OFDM) transmission, the method comprising:
estimating a clock offset of the received signal and generating a first signal in which a clock offset between transmission and reception is corrected;
performing symbol synchronization on the first signal, estimating a fine frequency offset, and generating a second signal in which the fine frequency offset is compensated for;
converting the second signal to a frequency domain signal, and performing frequency synchronization and frame synchronization;
estimating a residual frequency offset of the synchronized second signal, and generating a third signal in which the residual frequency offset is compensated for; and
performing channel distortion estimation and channel equalization on the received signal based on the third signal.

11. The method of claim 10, wherein the received signal is provided in a structure of a frame comprising a plurality of symbols.

12. The method of claim 11, wherein the generating of the first signal comprises estimating the clock offset based on a continuous pilot signal included in two consecutive symbols, among the plurality of symbols included in the received signal.

13. The method of claim 10, wherein the generating of the second signal comprises generating the second signal based on a feedback signal associated with the residual frequency offset of the synchronized second signal.

14. The method of claim 10, wherein the generating of the third signal comprises performing burst noise filtering on the third signal.

15. A method of configuring a frame for offset compensation in high-order modulated orthogonal frequency division multiplexing (OFDM) transmission, the method comprising:
configuring a frame comprising a pilot signal for transmission and reception synchronization and multicarrier channel distortion estimation;
converting a frequency domain signal to a time domain signal by performing a block based operation on the frame, and eliminating channel interference; and
converting a digital signal associated with the frame to an analog signal, performing conversion to a radio frequency (RF) band and amplification on the frame, and transmitting the frame.

16. The method of claim 15, wherein the configuring comprises configuring the frame by inserting a continuous pilot signal into subcarrier channels included in a plurality of symbols.
